(19) United States
(12) Patent Application Publication
(10) Pub. No.: US 2026/0109581 A1
(43) Pub. Date: Apr. 23, 2026

(54) TELESCOPIC CRANE ARM

(71) Applicant: EPSILON Kran GmbH., Salzburg (AT)

(72) Inventors: Stefan NEUREITER, St. Koloman (AT); Simon SCHOERGHOFER, Puch bei Hallein (AT)

(21) Appl. No.: 19/360,550

(22) Filed: Oct. 16, 2025

(30) Foreign Application Priority Data
Oct. 18, 2024 (EP) 24 207 450.8

(51) Int. Cl. B66C 23/70; A01G 23/00; B60P 1/54; B66C 13/14; B66C 23/36

(52) U.S. Cl. CPC B66C 23/705; A01G 23/003; B60P 1/54; B66C 13/14; B66C 23/36; B66C 23/707

(57) ABSTRACT

A telescopic crane arm including a boom with a bearing area for a boom extension, a boom extension movable out of and into the bearing area of the boom by travel movements so that a tip of the boom extension protrudes more or less far from the boom. The boom extension has a body at least partially in the form of a hollow profile, and a supply line is configured to simultaneously transmit both electrical energy and data signals. The supply line runs from the boom via the hollow profile of the boom extension to or at least in the vicinity of the tip of the boom extension, and is mounted and configured such that the supply line follows the travel movements. A mechanical tensioning device holds the supply line under mechanical tensile stress during the travel movements.

### BACKGROUND OF THE INVENTION

The invention relates to a telescopic crane arm, a crane with such a telescopic crane arm, and a vehicle with such a crane.

In order to drive the travel movements of the boom extension relative to the boom, a hydraulic piston-cylinder unit being supplied with hydraulic fluid via a hydraulic line is often used. The hydraulic line for reinforcement usually has a metal braid in its casing and therefore acts as a mechanical spring.

Telescopic crane arms are often equipped with devices in the form of sensors or work devices at the tip, which have to be supplied with power and with which data exchange (at least unidirectionally from the sensor to an evaluation unit) has to be ensured. Space is limited at the tip of the boom extension, and every additional kilogram reduces the lifting force. Supply lines should be arranged in an as space-saving as possible and protected manner.

A previous solution looks as follows (see, for example, EP 3 472 089 B1). A supply line is connected to an existing hydraulic line. The mechanical prestressing in the hydraulic line ensures that the supply line does not rub against or chafe other components.

This solution, with the supply line inside and connected to the hydraulic line, does protect the supply line from external influences, however, mechanical prestressing is required by the hydraulic line. If a cable break occurs in the system, both the hydraulic line and the supply line must be inspected. Due to the shared routing with the hydraulic line, the possible diameter of the supply line is limited by the hydraulic line. The use of multipolar supply lines is not possible.

In other previous solutions, a wireless connection to the tip of the boom extension is provided, which must be powered by a battery. These solutions therefore require space and weight at the tip. Electromagnetic fields can interfere with transmission. Interference cannot be easily detected in a wireless system.

### SUMMARY OF THE INVENTION

The task is to provide a telescopic crane arm, a crane with such a telescopic crane arm, and a vehicle with such a crane, with which the disadvantages of the previous solutions can be avoided.

This task is solved by a telescopic crane arm as described below, a crane with such a telescopic crane arm, and a vehicle with such a crane. Such a telescopic crane arm has a boom, a boom extension, a supply line, and a mechanical tensioning device.

The boom has a bearing area for the boom extension.

The boom extension can be moved out of and into the bearing area of the boom by travel movements, so that a tip of the boom extension protrudes more or less far from the boom, wherein the boom extension has a body which at least in sections is in the form of a hollow profile.

The supply line is suitable for simultaneously transmitting both electrical energy and data signals, wherein the supply line runs from the boom via the hollow profile of the boom extension (ie, inside the boom extension) to or at least in the vicinity of the tip of the boom extension and is mounted in such a way and designed with such a length that it can follow the travel movements. Simultaneously transmitting electrical energy and data signals is possible because there is no need for joint routing with a hydraulic line.

The mechanical tensioning device keeps the supply line under mechanical tensile stress during the travel movements. By providing a dedicated mechanical tensioning device for the supply line, it is no longer necessary to utilize the spring properties of a hydraulic line. The supply line can be installed independently of a hydraulic line, which provides more space and allows the advantages over wireless solutions to be maintained.

In one embodiment, the at least one mechanical tensioning device is arranged in the region of the tip of the boom extension.

In one embodiment, the at least one mechanical tensioning device has at least one first tensioning part, which is firmly connected to the boom extension, and at least one second tensioning part, which is firmly connected to the supply line. The mechanical tensioning device has at least one energy storage device, which applies force to the at least one first tensioning part relative to the at least one second tensioning part, so that the at least one mechanical tensioning device holds the supply line under mechanical tensile stress during the travel movements.

In one embodiment, the at least one first tensioning part and/or the at least one second tensioning part and/or the at least one energy storage device are arranged in the cavity of the boom extension.

In one embodiment, at least one energy storage device is designed in the form of a coil spring, and preferably the at least one supply line runs lengthwise through the at least one coil spring.

The at least one first tensioning part of the at least one mechanical tensioning device can have a sleeve-shaped section connected to the boom extension, in which the at least one coil spring is mounted at least in sections.

The at least one supply line can run through the sleeve-shaped section and preferably also through the at least one coil spring.

In a mechanical tensioning device with at least one first tensioning part and at least one second tensioning part, the at least one second tensioning part of the at least one mechanical tensioning device has at least one connecting part, via which the at least one second tensioning part is firmly connected to the supply line at at least one defined location along the supply line.

At least one connecting part of the at least one second tensioning part is designed as a cable clamp.

In one embodiment, at least one hydraulic line is provided, which runs from the boom via the hollow profile of the boom extension to or at least in the vicinity of the tip of the boom extension and is mounted in such a way that it can follow the travel movements. The at least one hydraulic line runs separately from the at least one supply line and its at least one mechanical tensioning device. The at least one hydraulic line can, for example, be provided for supplying a hydraulic piston-cylinder unit, via which the travel movements can be driven. In addition or alternatively, the at least one hydraulic line can, for example, be provided for supplying a hydraulically driven work device, which can be arranged on the boom extension. Typically, the at least one hydraulic line in its casing has a metal braid for reinforcement and therefore functions as a mechanical spring, so that no additional separate mechanical tensioning device is required for the at least one hydraulic line.

At least one separation point for two sections of the at least one hydraulic line is arranged on the boom, preferably in the form of a sheet metal plate, wherein the supply line is arranged at the separation point via a cable clamp.

In one embodiment, the supply line has at least:
one power cable for transmitting electrical energy and one data cable for transmitting data signals, or
one at least three-pole cable for simultaneously transmitting electrical energy and data signals, or
one hybrid cable with at least one power cable and at least one fiber optic cable for transmitting data signals.
These embodiments enable the simultaneous transmission of electrical energy and data signals in a simple manner. If more than one cable is provided, the cables can be connected in a common casing, which is connected to the at least one mechanical tensioning device, or can be connected individually to the at least one mechanical tensioning device.

In one embodiment, at least one device—preferably a sensor and/or a work device (e.g., a rotator)—is arranged in the region of the tip of the boom extension, which device can be supplied with electrical energy by the at least one supply line and can send and/or receive data signals via the at least one supply line. One and the same device is simultaneously supplied with power and can send and/or receive data signals, or that at least two devices are present, one of which is only supplied with power and the other of which can only send and/or receive data signals. In any case, both electrical energy and data signals are transmitted simultaneously through the at least one supply line.

In one embodiment of a crane with a telescopic crane arm, the at least one telescopic crane arm is mounted in an articulated manner on at least one further crane arm and at least one device to be supplied with electrical energy and/or data signals is connected to the boom extension and the mechanical tensioning device is arranged:
on the boom extension, preferably in the region of the tip of the boom extension, or
on the at least one further crane arm, or
on or in the at least one device (in the case of a rotator, preferably on the rotationally fixed part thereof).

The telescopic crane arm is particularly preferred for use in a loading crane or forestry crane.

### BRIEF DESCRIPTION OF THE DRAWINGS

Embodiments will be discussed in more detail below with reference to the drawings, in which:

FIG. 1 shows an example of a telescopic crane arm,

FIG. 2 shows a mechanical tensioning device,

FIG. 3 shows a mechanical tensioning device,

FIG. 4 shows an example of a telescopic crane arm,

FIG. 5 shows an example of a telescopic crane arm,

FIG. 6 shows a detailed view of an embodiment of a telescopic crane arm,

FIG. 7 is a detailed view of an embodiment of a telescopic crane arm, and

FIG. 8 shows a vehicle with a crane that has a telescopic crane arm.

### DETAILED DESCRIPTION OF THE INVENTION

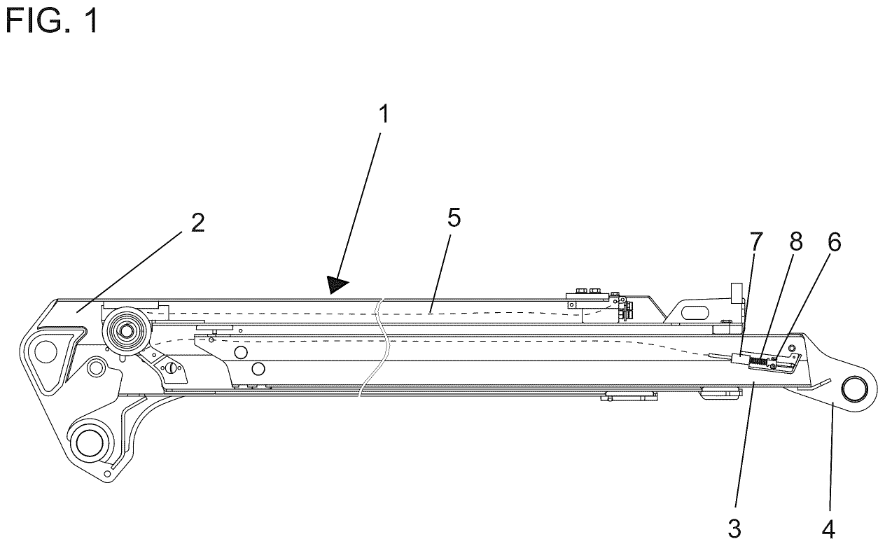

FIG. 1 shows a telescopic crane arm 1, including a boom 2, a boom extension 3, a supply line 5, a hydraulic line 9, and a mechanical tensioning device. The boom 2 has a bearing area for the boom extension 3.

The boom extension 3 can be moved out of and into the bearing area of the boom 2 by means of travel movements, so that a tip 4 of the boom extension 3 protrudes more or less far from the boom 2, wherein the boom extension 3 has a body which is at least partially in the form of a hollow profile. A drive device for driving the travel movements is not shown.

The hydraulic line 9 runs from the boom 2 via the hollow profile of the boom extension 3 to or at least in the vicinity of the tip 4 of the boom extension 3 and is mounted in such a way that it can follow the travel movements, wherein the at least one hydraulic line 9 runs separately from the at least one supply line 5 and its mechanical tensioning device.

The supply line 5 is suitable for simultaneously transmitting both electrical energy and data signals, wherein the supply line 5 runs from the boom 2 via the hollow profile of the boom extension 3 to or at least in the vicinity of the tip 4 of the boom extension 3 and is mounted in such a way and designed with such a length that it can follow the travel movements.

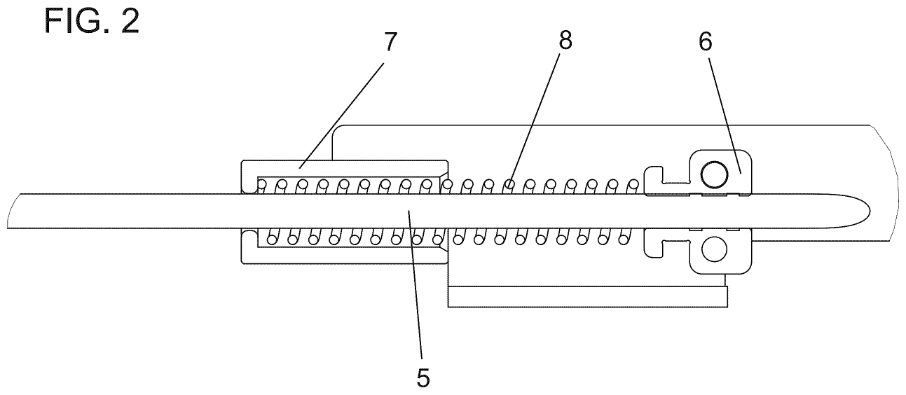

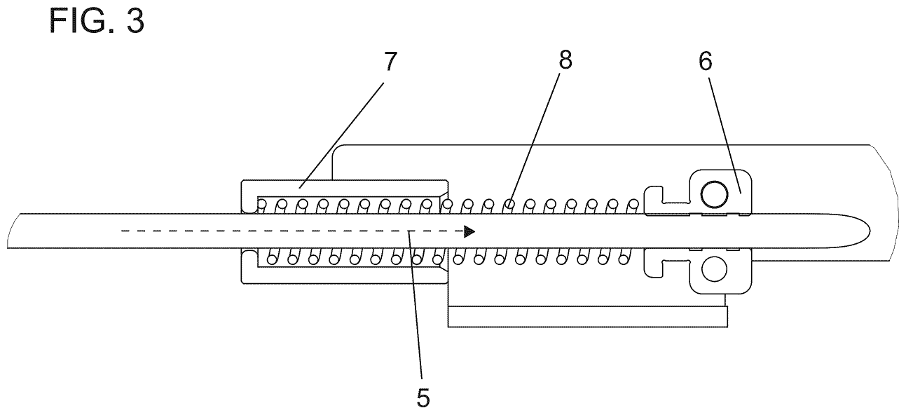

The mechanical tensioning device keeps the supply line 5 under mechanical tensile stress during the travel movements and, in this embodiment, is arranged in the region of the tip 4 of the boom extension 3, wherein, in this case, the mechanical tensioning device comprises (see also FIGS. 2 and 3):
a first tensioning part 6, which is firmly connected to the boom extension 3,
a second tensioning part 7, which is firmly connected to the supply line 5, and
an energy storage device 8, which applies force to the first tensioning part 6 relative to the second tensioning part 7, so that the mechanical tensioning device holds the supply line 5 under mechanical tensile stress during the travel movements.

In the embodiment shown, the first tensioning part 6, the second tensioning part 7, and the energy storage device 8 are arranged inside the cavity of the boom extension 3.

The energy storage device 8 is designed in the form of a coil spring, and the supply line 5 runs through the coil spring lengthwise.

The first tensioning part 6 has a sleeve-shaped section connected to the boom extension 3, in which the coil spring is mounted at least in sections, wherein the supply line 5 runs through the sleeve-shaped section and also through the coil spring.

The second tensioning part 7 has a connecting part via which the second tensioning part 7 is firmly connected to the supply line 5 at at least one defined location along the supply line 5 and which, in the embodiment shown, is designed as a cable clamp.

At least one separation point 12 for two sections of the hydraulic line 9 is arranged on the boom 2, preferably in the form of a sheet metal plate, wherein the supply line 5 is arranged at the separation point 12 via a cable clamp 13.

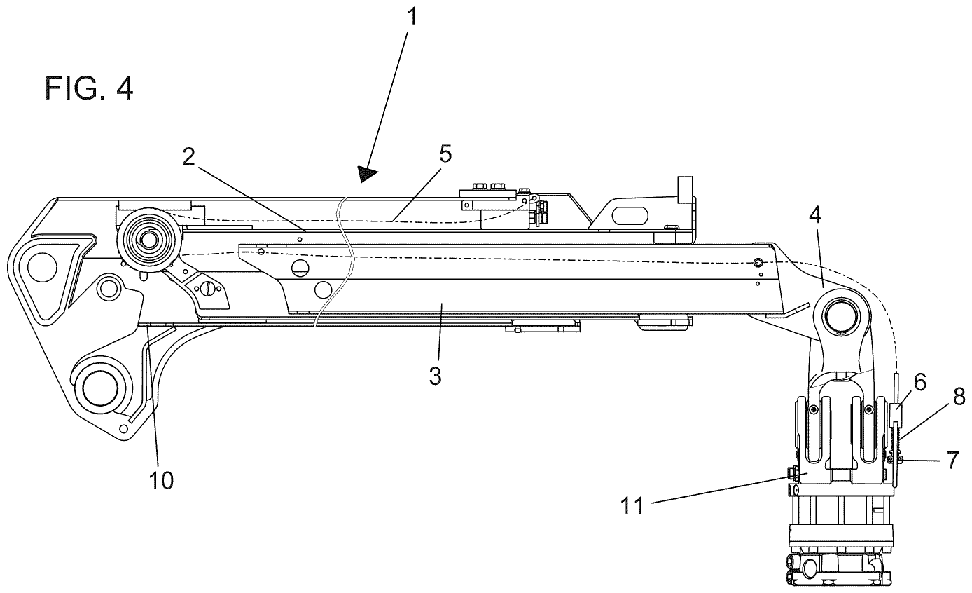

In FIG. 4, the telescopic crane arm 1 is connected to a further crane arm 10, and a device 11 in the form of a rotator is arranged at the tip 4 of the boom extension 3. In this embodiment, the mechanical tensioning device is arranged on the rotationally fixed part of the rotator.

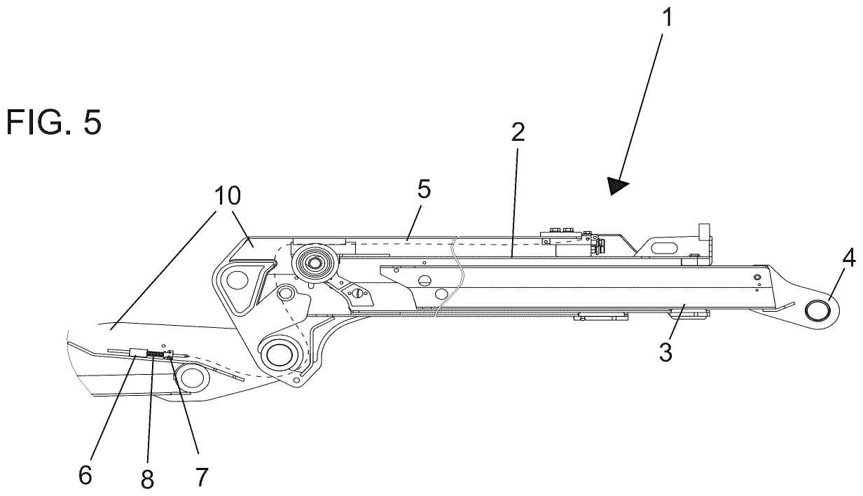

In FIG. 5, the telescopic crane arm 1 is connected to two further crane arms 10, one of which is a main arm. In this embodiment, the mechanical tensioning device is arranged on the main arm.

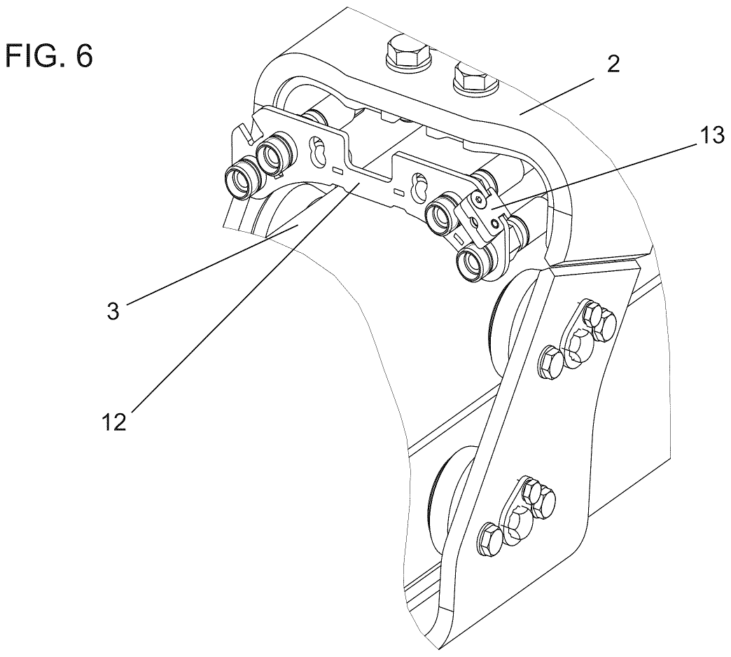

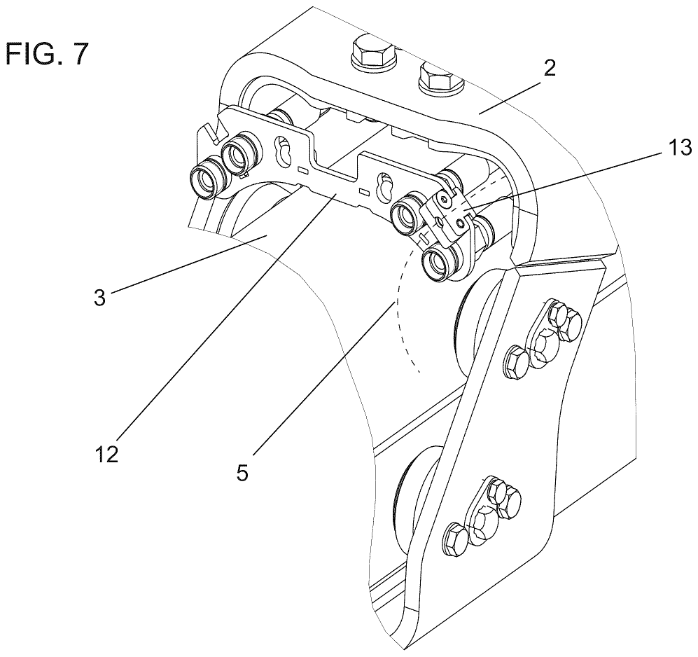

In FIGS. 6 and 7 it can be recognized that a separation point 12 for two sections of the hydraulic line 9 is arranged on the boom 2, in this case, in the form of a sheet metal plate, wherein the supply line 5 is arranged at the separation point 12 via a cable clamp 13.

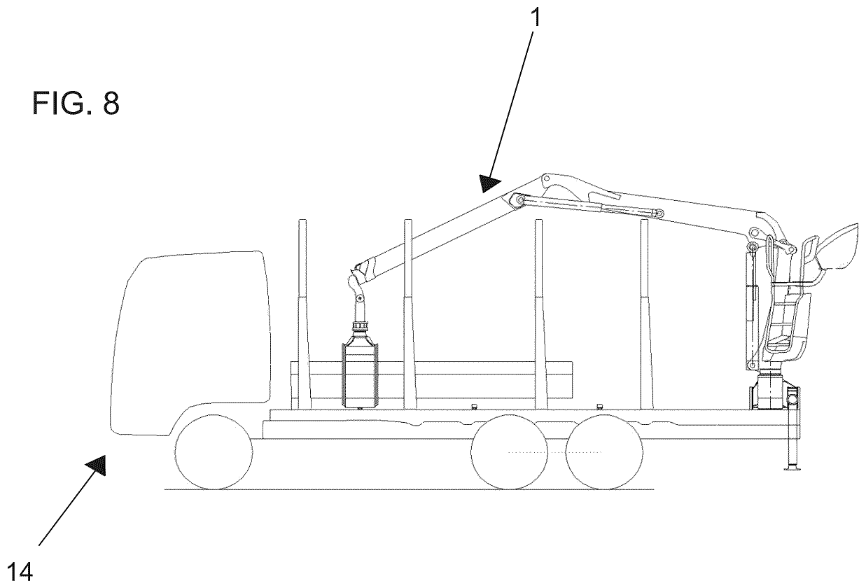

FIG. 8 shows a vehicle 14 with a crane, which has a telescopic crane arm 1 according to one of the embodiments shown.

### REFERENCES

1 telescopic crane arm
2 boom
3 boom extension
4 tip of the boom extension
5 supply line
6 first tensioning part of the mechanical tensioning device
7 second tensioning part of the mechanical tensioning device
8 energy storage device
9 hydraulic line
10 additional crane arm
11 work device
12 separation point
13 cable clamp
14 vehicle

1. A telescopic crane arm comprising:
a boom with a bearing area for a boom extension,
a boom extension configured to be moved out of and into the bearing area of the boom by travel movements, so that a tip of the boom extension protrudes more or less far from the boom, the boom extension having a body at least partially in the form of a hollow profile,
a supply line configured to simultaneously transmit both electrical energy and data signals, the supply line runs from the boom via the hollow profile of the boom extension to or at least in the vicinity of the tip of the boom extension, and is mounted and configured with such a length that the supply line follows the travel movements, and
a mechanical tensioning device configured to hold the supply line under mechanical tensile stress during the travel movements.

2. The crane arm according to claim 1, wherein the at least one mechanical tensioning device is arranged in the region of the tip of the boom extension.

3. The crane arm according to claim 1, wherein the at least one mechanical tensioning device has at least one first tensioning part which is firmly connected to the boom extension and has at least one second tensioning part which is firmly connected to the supply line, wherein the at least one mechanical tensioning device comprises at least one energy storage device which applies force to the at least one first tensioning part relative to the at least one second tensioning part so that the at least one mechanical tensioning device holds the supply line under mechanical tensile stress during the travel movements.

4. The crane arm according to claim 3, wherein the at least first tensioning part and/or the at least second tensioning part and/or the at least one energy storage device are arranged in the cavity of the boom extension.

5. The crane arm according to claim 3, wherein at least one energy storage device is designed in the form of a coil spring, and it is preferably provided that the at least one supply line runs lengthwise through the at least one coil spring.

6. The crane arm according to claim 5, wherein the at least one first tensioning part of the at least one mechanical tensioning device has a sleeve-shaped section connected to the boom extension, in which the at least one coil spring is mounted at least in sections.

7. The crane arm according to claim 6, wherein the at least one supply line runs through the sleeve-shaped section and preferably also through the at least one coil spring.

8. The crane arm according to claim 3, wherein the at least one second tensioning part of the at least one mechanical tensioning device has at least one connecting part, via which the at least one second tensioning part is firmly connected to the supply line at at least one defined location along the supply line.

9. The crane arm according to claim 8, wherein at least one of the connecting parts of the at least one second tensioning part is designed as a cable clamp.

10. The crane arm according to claim 1, wherein at least one hydraulic line is provided that runs from the boom via the hollow profile of the boom extension to or at least in the vicinity of the tip of the boom extension and is mounted in such a way that it can follow the travel movements, wherein the at least one hydraulic line runs separately from the at least one supply line and its at least one mechanical tensioning device.

11. The crane arm according to claim 10, wherein at least one separation point for two sections of the at least one hydraulic line is arranged on the boom, preferably in the form of a sheet metal plate, wherein the supply line is arranged via a cable clamp at the separation point.

12. The crane arm according to claim 1, wherein the supply line comprises at least:
a power cable for transmitting electrical energy and a data cable for transmitting data signals, or
an at least three-pole cable for the simultaneously transmitting electrical energy and data signals, or
a hybrid cable with at least one power cable and at least one fiber optic cable for transmitting data signals.

13. The crane arm according to claim 1, wherein at least one device—preferably a sensor and/or a work device—is arranged in the region of the tip of the boom extension, which device can be supplied with electrical energy by the at least one supply line and which device can send and/or receive data signals via the at least one supply line.

14. A crane, in particular a loading crane or forestry crane, comprising:
at least one telescopic crane arm including:
a boom with a bearing area for a boom extension,
a boom extension configured to be moved out of and into the bearing area of the boom by means of travel movements, so that a tip of the boom extension protrudes more or less far from the boom, wherein the boom extension has a body which is at least partially in the form of a hollow profile, and
a supply line, which is suitable for simultaneously transmitting both electrical energy and data signals, wherein the supply line runs from the boom via the hollow profile of the boom extension to or at least in the vicinity of the tip of the boom extension and is mounted in such a way and designed with such a length that it can follow the travel movements,
wherein it is preferably provided that the at least one telescopic crane arm is mounted in an articulated manner on at least one further crane arm, and
a mechanical tensioning device configured to hold the supply line under mechanical tensile stress during the travel movements.

15. The crane according to claim 14, wherein the at least one telescopic crane arm is mounted in an articulated manner on at least one further crane arm and at least one device to be supplied with electrical energy and/or data signals is connected to the boom extension and the mechanical tensioning device is arranged:
on the boom extension, preferably in the region of the tip of the boom extension, or
on at least one further crane arm, or
on or in the at least one device.

16. A vehicle, in particular a truck, with at least one crane according to claim 14.
